(19) United States
(12) Patent Application Publication
(10) Pub. No.: US 2015/0338072 A1
(43) Pub. Date: Nov. 26, 2015

(54) Click!Click! Swimming Pool Light

(71) Applicants: Erika Eunice Garcia, Houston, TX (US); Jose Enrique Garcia, Houston, TX (US)

(72) Inventors: Erika Eunice Garcia, Houston, TX (US); Jose Enrique Garcia, Houston, TX (US)

(21) Appl. No.: 14/715,523

(22) Filed: May 18, 2015

Related U.S. Application Data
(60) Provisional application No. 61/994,682, filed on May 16, 2014.

(51) Int. Cl. F21V 21/08; F21V 31/00; F21V 23/04; F21V 9/08; F21V 9/10; F21S 8/00; F21S 9/02

(52) U.S. Cl. CPC F21V 21/0808; F21S 8/033; F21V 31/005; F21S 9/02; F21V 9/08; F21V 9/10; F21V 23/04; F21W 2131/401

(57) ABSTRACT

A wireless, battery powered, waterproof LED accent light that is submersible in a swimming pool, comprising: a self adhering base mountable to a side wall of a pool, a pressure activated lighting fixture comprising a battery powered ultra bright LED light set in a watertight frame that is easily attachable to the base, and a translucent and interchangeable colored lens that is placed over the lighting fixture component to change the color of the light projecting from the light fixture.

### CLAIM OF PRIORITY

This patent application claims priority under 35 USC 119 (e) (1) from U.S. Provisional Patent Application Ser. No. 61/994,682 filed May 16, 2014, of Erika Garcia and Jose Garcia herewith entitled, “Click! Click! Swimming Pool Light,” which is incorporated herein by reference as though the same were set forth in its entirety.

### FIELD OF THE INVENTION

The present invention pertains to the field of lighting, and more specifically to the field of illuminated accent lighting for swimming pools.

### BACKGROUND OF THE INVENTION

The prior art has put forth several designs for illuminated accent lighting for swimming pools. Among these are:

U.S. Pat. No. 8,337,040 to Matthew N. Easley describes a light emitting assembly for a housing with a perimeter wall and an open bottom side. A water buoyant material is attached to the perimeter wall. A light emitter is mounted to the housing. The light emitter emits a light when power is provided to the light emitter. At least one battery component is mounted to the housing. The at least one battery component is electrically coupled to the light emitter. The at least one battery component is exposed through the bottom side of the housing to allow water to enter the at least one battery component. The at least one battery generates electricity when water enters the bottom side of the housing. The housing is placed in water so that the water acts as an electrolyte for the at least one battery component to provide electricity to the light emitter.

US Patent 2007/0153523 to David Thornhill, Kevin Tarter and Darin Webb describes a flashlight that includes contacts that close a circuit when the flashlight is in water. The closed circuit provides a connection between batteries and a lamp, lighting the lamp. The flashlight is sealed so that it floats when dropped in the water.

U.S. Pat. No. D543,296 to John Charles Tutton, Jason Florent Busschaert and Aldo Balatti describes an ornamental design for a floating pool light.

None of these prior art references describe the present invention.

### SUMMARY OF THE INVENTION

It is an object of the present invention to provide is a wireless, battery powered, waterproof LED accent lighting that is submersible in a swimming pool.

### BRIEF DESCRIPTION OF THE DRAWINGS

FIG. 1 is an illustrative prototypical top down view showing three components of the present invention with the first component being a mounting plate with a self adhesive backing, the second component being a battery compartment, and the third component being an interchangeable lens.

FIG. 2 is a functional diagonal view showing two prototypes of the present invention mounted on a side wall in a swimming pool.

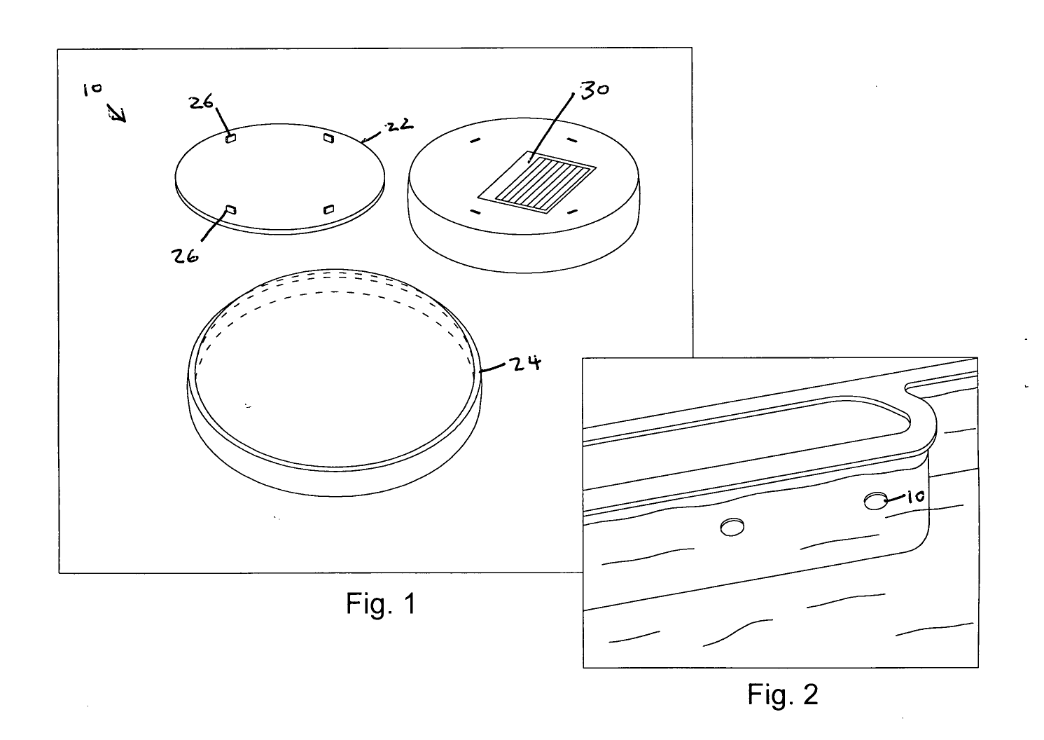

### DETAILED DESCRIPTION OF THE INVENTION

For people who own private swimming pools, a pool provides hours of relaxation and recreation. Along with pool ownership comes with expenses such as cleaning and chemical costs, and maintaining pool decking or grounds. An additional expense goes into pool lighting if an owner wants to enjoy their pool at night. A well lit pool looks stunning and provides nighttime swimmers with an additional element of safety. Professional pool technicians field many customer requests regarding available options for additional pool lighting to enhance nighttime enjoyment of their private pools. The main option available is to install hardwired permanent pool lighting fixtures which often proves to be extremely difficult and costly.

The present invention, hereinafter referred to as the Click! Click! Swimming Pool Light, or simply Click! Click!, is a wireless, battery powered, waterproof LED pool accent light. Applied with self adhesive backing, these lights are quickly and easily installed in a swimming pool by a pool owner. Click! Click! is manufactured in a variety of colored housings and lenses, as well as a range of different sizes between approximately two inches to ten inches in diameter. Powered on and off simply by pushing the light until it clicks, the present invention permits a pool owner to quickly and easily light any pool that is under lit. Click! Click! lights are easy to remove, so a pool owner may easily change batteries or restructure the pool lighting scheme.

Please refer to the Figures. Click! Click! is comprised of three basic components. The first component is a self adhering base 22 mountable to a side wall of a pool. The second component is a pressure activated lighting fixture 28 comprising a battery powered ultra bright LED light set in a watertight frame that is easily attachable or removable from the base. Slots in the bottom of the lighting fixture fit over three or four L shaped hooks 26 protruding from the aforementioned base component 22. Batteries are housed in battery compartment 30, which is integral to the light fixture 28. The third component is a translucent and interchangeable colored lens 24 that is placed over the lighting fixture 28 component to change the color of the light projecting from the present invention.

Installing Click! Click! has several advantages over installing traditional lighting. An owner can purchase the lights and immediately install them without waiting to schedule an electrician and then needing to empty the pool water when time to do the electrical work. The battery operated LED lights eliminate a need to run a one hundred twenty volt electrical line into the pool and risk grounding issues that can create a serious electrical hazard. Self contained and self adhering, there is no need to cut into the pool and risk damaging the pool tiles or the pool's structural stability. The pool is left unaltered and unharmed. Third, if there is an issue, the fixture is easily removed and fixed or replaced. If owners become functionally or aesthetically unhappy with their light arrangement, they have options to move lights or change the color of the lights. If batteries are low, the light is easily removable for replacing the old battery with a new battery. LED lights use very little electricity, but the on and off push functionality permits a pool owner to turn the lights off anytime.

Beyond having a highly effective functional and aesthetic appeal for homeowners with pools, Click! Click! is usable in a bathtub or a jacuzzi. The present invention is highly functional for pools in hotel complexes, sport facilities, educational facilities and water parks. Click! Click! also functions as substitute lighting when existing pool lighting is being repaired or replaced. Imaginatively decorative with a wide range of alluring color, conveniently easy and safe to install and remove, and affordably practical, Click! Click! will withstand years of continued use.

Although this invention has been described with respect to specific embodiments, it is not intended to be limited thereto and various modifications which will become apparent to the person of ordinary skill in the art are intended to fall within the spirit and scope of the invention as described herein taken in conjunction with the accompanying drawings and the appended claims.

1. A wireless, battery powered, waterproof LED accent light that is submersible in a swimming pool, comprising: a self adhering base mountable to a side wall of a pool, a pressure activated lighting fixture comprising a battery powered ultra bright LED light set in a watertight frame that is easily attachable to the base, and a translucent and interchangeable colored lens that is placed over the lighting fixture component to change the color of the light projecting from the light fixture.

2. The waterproof accent light of claim 1 wherein slots in the bottom of the lighting fixture attach to the base by means of three or four L shaped hooks protruding from the base component.

3. The waterproof accent light of claim 2, wherein batteries are housed in battery compartment, which is integral to the light fixture.

4. The waterproof accent light of claim 2, manufactured in a variety of colored housings and lenses.

5. The waterproof accent light of claim 2, manufactured in a range of different sizes between approximately two inches to ten inches in diameter.
